(19) United States
(12) Patent Application Publication
(10) Pub. No.: US 2025/0221345 A1
(43) Pub. Date: Jul. 10, 2025

(54) A SPREADER APPARATUS

(71) Applicant: SPREAD-A-BALE LIMITED, Chester (GB)

(72) Inventor: Michael HUGHES, Cheshire (GB)

(21) Appl. No.: 18/871,609

(22) PCT Filed: May 4, 2023
(86) PCT No.: PCT/GB2023/051183

§ 371 Date: Dec. 4, 2024

(30) Foreign Application Priority Data
May 4, 2022 (GB) 2206499.2

(51) Int. Cl. A01F 29/00; A01F 29/09; A01F 29/16

(52) U.S. Cl. CPC A01F 29/005; A01F 29/095; A01F 29/16

(57) ABSTRACT

A bale spreading apparatus comprising a box frame which retains a bale of material, a conveyor on which a bale rests, the conveyor being operative to urge the bale in a longitudinal direction towards a spreader head which ejects bale material from the apparatus, wherein the spreader head comprises one or more rotors, the or each rotor comprising a vertically mounted rotatable shaft and a series of blades being mounted on at least one of said shafts.

### TECHNICAL FIELD OF THE INVENTION

The present invention relates to a spreadier apparatus for spreading material such as straw, hay or lucerne, which is more commonly known as a bale handling apparatus. Such apparatus is used to distribute elements of a bale (such as a straw bale, for example) typically, though not exclusively for the purpose of spreading the straw on the ground.

### BACKGROUND TO THE INVENTION

Such apparatuses are known per se. One example of such an apparatus is disclosed in EP 0944300 which discloses a bale-spreading apparatus that may be mounted to a tractor or other agricultural vehicle via an extended, hydraulically operated arm, known as a loader.

FR2765773 discloses an agricultural machine for shredding straw, comprising a crate and a conveyor belt formed from two endless chains to drive the straw towards a shredder.

Another example is disclosed in EP 2804465 which discloses a bale handling apparatus having a frame which retains a bale of material, a conveyor surface mounted on the frame and upon which the bale rests, the conveyor surface being operable to move the bale toward a spreader head that ejects bale material from the apparatus, wherein the apparatus includes at least one supporting strut, forming part of the frame and being located under the conveyor surface.

There is a need to provide an alternative apparatus enabling, inter alia, mounting of the apparatus in such a manner that the bale can be more easily loaded and/or more evenly dispersed, longitudinally or to the side.

### SUMMARY OF THE INVENTION

According to a first aspect of the invention, there is provided a bale spreading apparatus comprising a box frame which retains a bale of material, a conveyor on which a bale rests, the conveyor being operative to urge the bale in a longitudinal direction towards a spreader head which ejects bale material from the apparatus, wherein the spreader head comprises one or more horizontally mounted rotatable shafts, a series of blades being mounted on at least one of said shafts.

According to a second aspect of the invention, there is provided a bale spreading apparatus comprising a box frame which retains a bale of material, a conveyor on which a bale rests, the conveyor being operative to urge the bale in a longitudinal direction towards a spreader head which ejects bale material from the apparatus, wherein the spreader head comprises one or more vertically mounted rotatable shafts, a series of blades being mounted on at least one of said shafts.

Optionally all of the blades are mounted relative to a single shaft.

Typically, the apparatus is mounted relative to a tractor or similar device to allow the that bale material is ejected to any side of the tractor. Normally, the apparatus is mounted relative to an articulated arm.

The apparatus may be mounted longitudinally, that is mounted so that the direction of rotation of the conveyor is substantially the same as the direction of travel of the tractor. Alternatively, the apparatus may be mounted transversely, that is mounted so that the direction of rotation of the conveyor is substantially perpendicular relative to the direction of travel of the tractor.

Optionally no more than two blades are provided in any line of circumference on the shaft. In other words, more than one blade is preferably provided but preferably there are no more than two blades which are radially aligned in any single plane. If four blades are provided, they would all be offset radially, or two blades would be aligned in one radial plane and the other two blades would be aligned in another radial plane. If more blades were provided, then they could all be offset from one another or provided in pairs aligned in a radial plane with each pair of set.

Preferably, laterally adjacent blades will be radially offset from one another.

Optionally a pair of blades are provided as the respective opposite tips of an elongate member extending around and from opposite sides of the shaft.

Optionally blades are spaced apart along the shaft. In one embodiment, the blades are evenly spaced apart on the shaft.

Optionally adjacent blades are spaced apart along the shaft by 10 cm to 20 cm. In one embodiment, this distance is 15 cm.

Optionally the tips of the blades are spaced apart from the centre of the shaft by a length between 40 cm and 60 cm. In one embodiment this distance is 50 cm. Depending upon the height of the apparatus and/or the height of the bale, the shaft mounting the blades may be movable up and down during spreading. Preferably, the shaft may be driven up and down. Any movement of the shaft relative to which the blades are mounted will typically be linear. Preferably, the movement of the shaft will reciprocate.

Optionally the blades are each set at 45° to an adjacent blade on the shaft.

Optionally the blades are arranged such that a blade tip is provided every 45° around the shaft, when viewed along the shaft.

Optionally one motor drives rotation of a single shaft and all of the blades mounted relative to the blades. The motor may be mounted in line with the shaft. A direct coupling of the motor into the rotor shaft, may be provided. This removes the need for a chain and sprocket drive system, and rotor drive couplings which connect the motor to the rotor. An additional rotor bearing may be provided to support the motor, with direct drive from the motor output shaft into the rotor shaft.

The single shaft may be mounted substantially centrally of the apparatus relative of the bale, whether the shaft is horizontal or vertical.

The rotor motor may be driven in both directions. Where the motor is a hydraulic motor, a bidirectional valve or similar may be provided to change the rotation direction of the rotor from clockwise to anti clockwise for feeding and bedding for example.

A regulator may be provided to regulate the speed of rotation of the rotor. A bidirectional valve may have a flow regulator fitted, to control and regulate the rotational speed of the rotor. The rotational speed could also be controlled by adjusting flow using a main flow proportioner in a main hydraulic manifold.

Each of the blades may be mounted relative to the shaft through provision of a rotor arm. Each rotor arm is preferably located on the rotatable shaft. The rotor arms are preferably planar. A rotor arm preferably extends on each side of the rotatable shaft approximately equally. A pair of rotor arms may be formed as a single unit. A substantially central aperture through which the rotatable shaft extends is preferably provided through the rotor arm. Each rotor arm may be broader at the root and narrower at the tip.

Each rotor arm is provided with or forms a blade for shredding the bales. The blade may be formed separately and attached relative to the free end of the rotor arm.

Each blade will preferably be shaped to optimise the breakup of the bale. Each blade will preferably be elongate. Each blade will preferably have a planar forward edge and a planar rear edge (in the direction of rotation). The tip of each blade will preferably be arcuate. In a preferred form, the tip will curve toward the root of the blade, rearwardly (relative to the direction of rotation).

The blade may be twisted or shaped relative to the direction of rotation. The blade may have an angled tip or a pointed tip. A centrally pointed blade tip may reduce the amount of friction, reducing drag and resistance and hence reducing the load on the motor which may reduce stalling.

Each blade may extend from adjacent to the root of the rotor arm and extend past the tip of the rotor arm. The blade may be attached to the rotor arm at at least two positions, a first position at an inner end of the blade which is located adjacent to the root of the rotor arm and a second position adjacent to the tip of the rotor arm (which is partway along the length of the blade. This configuration may allow the blade to reinforce or further strengthen the rotor arm.

The spreader apparatus includes a spreader chamber or box at least partially defining an internal volume into which one or more bales are received. In a preferred embodiment, the chamber will typically have a pair of upstanding side walls, rear wall, and a base, with a forward side closed by the spreader head. The spreader chamber will typically have an open top. The side walls may be webbed in profile, with portions removed to reduce weight.

In one form, the rear wall of the spreader chamber may be movable.

The base wall of the spreader chamber may be substantially defined by a conveyor. In one form, the conveyor may be a conveyor belt extending across the width of the internal volume and the length of the internal volume.

In an alternative form, a fixed, substantially solid base wall may be provided. The base wall may be located substantially transversely relative to the upstanding side walls and/or rear wall. The base wall will typically be spaced above a lower plane of the apparatus, which is preferably defined by a lower edge of the side walls. This configuration will preferably provide clearance beneath the underside of the base wall, above the lower plane of the apparatus.

The spreader head may be fixed or movable. Provision of a moveable spreader head will preferably allow the spreader to be loaded with one or more bales of material by raising the spreader head and then loading the one or more bales through the forward end of the spreader. If the spreader head is fixed, then provision will normally be made elsewhere in the spreader chamber to allow one or more bales to be loaded into the spreader chamber. This could be accomplished for example by providing the rear wall as a movable wall.

Generally, the base wall and upstanding side walls of the spreader chamber will define a substantially U-shaped profile with either a fixed rear wall, or a movable rear wall to at least partially define the chamber.

If the spreader head is movable, then a forward end of the spreader chamber may be provided with an angled portion or structure in front of the forward end of the conveyor. The angled portion or structure may be substantially triangular. The angled portion or structure may be angled to correspond with an angled forward end of the conveyor. In use, the forward end of the spreader (with the spreader head raised) can be moved to a position adjacent to a bale of material and the angled portion or structure then wedged beneath a part of the bale and moved until the conveyor (operating in a reverse direction during loading) engages with the bale to draw the bale into the spreader chamber. The spreader head can then be lowered.

The spreader head may be provided with an angled portion or structure. The angled portion or structure on the spreader head may be oriented in reverse to the angled portion or structure on the spreader chamber. This may create an angled depression when the spreader head is closed, which in turn may provided more clearance for the blades. It may form a choke point to increase the velocity of the material ejected.

A cowl may be provided on the spreader head. Where provided, the cowl may preferably extend forwardly from adjacent to a forward end of the angled portion or structure in front of the forward end of the conveyor. The angled portion or structure on the spreader head may be mounted between the cowl and the angled portion or structure in front of the forward end of the conveyor. A rear end edge of the cowl may align with a forward end of the angled portion or structure on the spreader head.

The cowl may be planar, angled or arcuate.

The cowl may be fixed or movable. In one form, a movable cowl may allow the cowl to be elevated above a substantially horizontal position. Elevating the cowl may allow choking of the material in the rotor. Choking the material in the rotor may act to enhance material throw trajectory and consequently spread distance. As the choking effect is increased by elevating the cowl angle, the distance of throw of the material ejected may increase.

The drive device such as a ram for example, may be provided attached to one end of one or more mounting arms which is/are mounted relative to a shaft with an opposite end of the one or more mounting arms associated with a portion of the cowl.

The cowl may be manufactured from any material.

The cowl may be mounted to or relative to the spreader head, whether the spreader head is provided in the fixed or movable configuration.

An upper part of the spreader head may be provided with a rotor safety guard structure. Preferably, one or more cover members may be provided to enclose an upper, forward side of the rotor. The cover members may be mounted to the sidewalls of the spreader head.

The apparatus may be provided with a deflector to deflect material as it leaves the apparatus. The deflector can be used to deflect material downwards into a feed trough, or feeder.

If the rear wall is a movable rear wall, it is preferred that the rear wall pivots about a lower side edge to form a ramp to allow loading of at least one bale into the spreader chamber from an end of the chamber opposite to spreader head. In one configuration, it is preferred that the ramp is a substantially planar member. Typically, the ramp/rear wall will extend across the width of the spreader chamber. Preferably, the lower end of the ramp/rear wall is substantially coplanar with the base wall of the spreader chamber and when lowered, will preferably angle downwardly.

The pivoting rear wall is simply one preferred embodiment of providing a movable rear wall and other configurations of movable rear wall may be provided, if preferred.

The apparatus of the present invention may include one or more bale chain drives. Preferably, more than one bale chain drive will be provided. Preferably, each of the bale chain drives is provided in the form of an endless chain with one or more engagement teeth extending upwardly from the chain within the spreader chamber.

In this configuration, the preferably solid base wall of the spreader chamber will typically be provided with an elongate opening for each of the bale chain drives so that the engagement teeth can extend above the level of the base wall over a working length during rotation of the chain so that the engagement teeth of the chain engage a bale and drive the bale toward the spreader head.

Where one or more bale chain drives are provided, is preferred that each of the blades of the spreader head are offset from each the bale chain drives.

The rotating blades of the spreader head will preferably extend rearwardly into the volume of the spreader chamber from a forward end of the spreader chamber, during rotation. The blades will typically extend further rearwardly than a forward end of the bale chain drives. In this configuration, the blades of the spreader head can begin breaking up the bale and dispersing the bale from a portion of the bale behind the forward end of the bale chain drives. This is normally not possible using a conveyor belt due to the potential that the blades may damage the conveyor belt during rotation.

Any number of bale chain drives may be provided. In a preferred configuration, at least two bale chain drives are provided, one on either lateral side of the longitudinal midline of the spreader chamber.

More than two bale chain drives may be provided depending upon parameters such as the configuration of the spreader chamber, the size of the spreader chamber, the type of bale to be spread and the like.

As mentioned above, each of the bale chain drives will typically extend longitudinally over at least a portion of the length of the spreader chamber. Preferably, the forward end of the bale chain drives will be located in front of the rearmost part of the rotating blades of the spreader head. Preferably the rear end of the bale chain drives will be located adjacent to and closely spaced from the rear wall of the chamber when closed, particularly in a rear loading configuration.

If the spreader is provided with one or more bale drive chains, then the cowl (if provided) may be fixed (or provided as a part of, or aligned with, the base wall) with the one or more bale drive chains turning about a forward cog or sprocket preferably located behind the cowl and beneath the level of the preferably fixed base wall.

The chain part of the respective bale drive chains will preferably be mounted below the level of the preferably fixed base wall, so that only a portion of each of the engagement teeth mounted relative to the chain extend above the upper surface of the base wall. At the extremities of the preferred endless chain loop, the chain will preferably extend about the cog or sprocket, and the return portion of the chain would then typically extend beneath the cog or sprocket and under the base wall in space provided beneath the base wall and above the lower plane of the apparatus.

Each of the endless chains of a bale chain drive will preferably be mounted for rotation relative to at least two cogs or sprockets. Preferably, each of the cogs or sprockets will be provided with a number of teeth to engage the chain of the bale chain drive and drive rotation of the chain. In a preferred form, one of the cogs or sprockets will be a drive cog or sprocket on the other will be free rotating cog or sprocket which rotates due to the rotation of the drive cog or sprocket and being linked by the preferred endless chain.

In some embodiments, both or more than one of the cogs or sprockets associated with a single bale drive chain may be a drive cog or sprocket.

Typically, a cog or sprocket is provided a forward end of each bale chain drive and a cog or sprocket is provided at the rear end of each bale chain drive. A cog or sprocket is provided a forward end of the spreader chamber and a cog or sprocket is provided at the rear end of the spreader chamber.

The cogs or sprockets will preferably be provided in number of sets, with the cogs or sprockets of each set mounted relative to a single shaft. Rotation of the shaft will preferably rotate each of the cogs or sprockets in a particular set or vice versa. The number of cogs or sprockets in a set will preferably correspond to the number of bale chain drives provided.

Each of the bale chain drives can be driven in a forward and a reverse direction, as chosen by an operator. All of the bale chain drives of an apparatus are typically driven in the same direction and at the same speed to stop skewing of the bale as it is driven forward.

One or more guide is preferably provided substantially over the length of each of the chains, between the cogs or sprockets. One or more guides may be provided for each of the chains. A guide may be located between the upper portion of each chain and a lower return portion of each chain to guide the chain portions and space the chain

It is preferred that any drive motor to drive the rotor is provided on the apparatus is mounted relative to one of the side walls of the spreader head, relative to an outer surface of the side wall.

The drive motors (to drive the rotor and/or the conveyor) are typically connected to a hydraulic circuit of the loader or tractor relative to which the apparatus is mounted.

In one preferred embodiment, a rear shaft associated with the conveyor is a driveshaft rotated by a drive motor.

Preferably, the drive motor to drive the rotor is associated appropriately with the drive motor to drive the conveyor to optimise the speed of advance of the bale with the rotation speed of the spreader shaft.

The spreader head of the apparatus of the present invention may be movable. In one preferred form, the spreader head is provided with a generally rectangular external frame, of a dimension which is substantially the same as the spreader chamber. A shaft is typically mounted transversely across the generally rectangular frame with the spreader blades mounted relative to the shaft.

A pair of mounting arms which extend rearwardly of the frame are each typically mounted relative to the pivot and upper area of the apparatus. One or more rooms are preferably provided to lift and lower the spreader head by driving the mounting arms up and down. In this configuration, the spreader head is typically lifted to load a bale and the lifting will typically move the entire spreader head out of the way of a forward end of the spreader chamber so that it can be loaded into the spreader chamber.

Typically, the blades will break up the bale and disperse the broken-up bale from the apparatus.

In one embodiment of the invention, the forward portion of the spreader chamber or box may be wider than a rear portion. A pair of convergent plates may be provided, converging toward one another, part way between the forward end of each of the sidewalls and the rear of each of the sidewalls. Typically, this will allow the spreader head to be of greater width than the rear portion of the spreader chamber or box. This will preferably lessen the material used and lighten the apparatus even further.

The convergent plates may converge at any angle but typically at an angle of between 5° and 15° and an angle of 5° to 10° is particularly preferred. The plates are preferably between 10 cm and 50 cm and most preferably around 30 cm in length.

In this embodiment, any supports which are external of the walls of the spreader chamber or box will preferably be absent. The spreader head with any raising and lowering arrangement will still be provided adjacent to a wider, forward end of the spreader chamber or box, which is typically open.

A forward portion of the sidewalls may be higher than a rear portion.

According to the second aspect, the apparatus may be configured for ‘side throw’ in which the material is ejected substantially sideways from a longitudinally mounted apparatus. A transversely mounted apparatus may be used to achieve the same aim but a transversely mounted apparatus but is quite long which requires more clearance. An apparatus configured for ‘side throw’ preferably allows a longitudinally mounted apparatus to eject material sideways, or at least at an angle to the direction of rotation of the conveyor.

A transversely mounted apparatus can be 4 m wide, requiring a 5 m wide clearance. With a longitudinally mounted side throw apparatus, the apparatus can be 1.75 m wide, enabling easy access into narrow doorways and passages.

Adopting the vertical rotor cowling to choke the rotor, facilitates side discharge/throw/spreading along narrow passageways, which are frequently found in farming.

The vertical rotor will preferably be modified at a lower end thereof. The lower end of the vertical rotor may have one or more rotor arms, and/or blades that are configured differently to allow for gravity. The lowermost rotor arm may be enlarged or oversized. The lowermost rotor arm may be provided with shorter blades. The lowermost rotor arm and/or blades may be provided to ‘sweep’ a central area about the lower end of the rotor to prevent material wrapping about the rotor at the lower end.

The lowermost rotor arm or blades may be provided with a vertical portion configured to act like a fan blade, creating an air flow force to ‘throw’ the material further, particularly if it is smaller. This may prevent material simply falling downward upon exiting the apparatus.

The blades may be rectangular in plan with a V shaped blade notch in the end of the blade, with the tip of the V-shape oriented toward the root of the blade. This shape with a longer straight edge provides more acceleration for the material, but the V-shaped notch may reduce the amount of friction and resistance as the rotor chokes the bale wafer which may prevent the rotor stalling.

In an embodiment, the bottom blades may have vertical planes or portions, up to 30 mm below the bottom blade holder, to scrape the lower surface about the rotor and generate air movement as the material is discharged, to throw the straw a bit further with pneumatic forces.

In an embodiment, the bottom blade holder can be fitted with a vertical blade or fin, which in one embodiment may be approximately 100 mm high, to generate air movement and pneumatic forces to throw the straw further with pneumatic forces.

The floor of the apparatus around the rotor and particularly within the span of the blades, is preferably planar. This may allow the lower blades to operate more efficiently. The planar floor may also interact with the vertical planes or portions or vertical blades or fins, described above to generate air movement and pneumatic forces.

A side throw apparatus may be provided with a substantially vertically extending cowling. The cowling may allow choking of the rotor, facilitate side discharge/throw/spreading along narrow passageways, which are frequently found in farming.

A pair of opposed cowlings may be provided, one on either lateral side of the spreader head. When used with a rotor which is drivable in either direction, this can facilitate left-hand side and right-hand side discharge/throwing/spreading of material.

The cowling may be moveable or have an adjustable position. The position of cowling may be adjustable between a fully closed position in which material is prevented from leaving the spreader head to any of one or more open positions. A fully open position may be one in which the cowling is substantially aligned with the direction of the conveyor. Where the discharge aperture defined by the cowling is small between 300 mm-500 mm wide, this is ideal for narrow doorways as found in horse stables and pig hutches.

With the position of the cowling (vertical rotor) or cowl (horizontal rotor), the position of the cowling/cowl may be adjustable to accommodate varying types of straw bales, wafer thickness and bale density. If the cowling/cowl is too tight at the compression point, the rotor will likely stall in the material.

After the compression point, the cowling can be adjustable/variable. If the rotor is choked too much, the material can return into the machine and not be ejected as intended. If not choked enough, throw distance is reduced and the rotor can stall and block. A cowling/cowl which is adjustable in position to optimise these factors is therefore preferred.

In one form, the apparatus may be provided with an exit deflector. The exit deflector may extend from adjacent to the sidewall or at least one choking deflector forwardly and lateral about a forward side of the rotor to guide material to one side of the apparatus.

The clearance between the inner side of the exit deflector and the tips of the blades may be between 30-60 mm as this will preferably act to accelerate the material outwardly and maintain a sufficient amount of material about the rotor.

The degree of choking is important as there should be a sufficient amount of material around the rotor so that the rotor can partially separate the material but does not break the material up further. The rotor should preferably separate, but not cut the material.

In one form, a single exit cowling/deflector is provided. The exit cowling/deflector may be moveable, allowing the direction of throw to be changed from right hand to left hand (with an appropriate rotation direction of the rotor). In an embodiment, the exit cowling/deflector may be rotatable, to change the direction.

The exit cowling/deflector may be moved by any mechanism such as a chain drive or a hydraulic drive. The mechanism will preferably be bi-directional to move the exit cowling/deflector in both directions.

The exit cowling/deflector may include a straight portion extending from adjacent to the sidewall or at least one choking deflector forwardly, an arcuate portion to change direction and a second straight portion at the exit side thereof. The rearmost straight portion may smooth the change of direction of the material from the sidewall or at least one choking deflector (described below). The forward straight portion at the exit preferably directs the material sideways, but not rearwardly. The exit cowling/deflector may be positioned such that the forward straight portion is oriented laterally, and preferably even slightly forwardly to ensure that material is not directed rearwardly.

In one form, the side throw apparatus may further comprise at least one and preferably a pair of opposed choking deflectors, located adjacent to the rotor (the axis of rotation of the rotor). The at least one choking deflector is preferably angled laterally inwardly toward the rotor. The at least one choking deflector may include an angled wall. The angled wall is preferably planar and smooth. The angled wall may extend from a point behind the rotor (the axis of rotation of the rotor in the feed direction) and extend to a point at least in line with the rotor (the axis of rotation of the rotor) and possible in front of the rotor (the axis of rotation of the rotor). The angled wall preferably extends inwardly towards the rotor from the plane of the sidewall of the apparatus.

A second wall or bracing assembly may extend away from the angled wall at an angle to hold the angled wall at the desired angle.

The angled wall and second wall or bracing assembly may be manufactured from a single piece of material bent or formed to have an angle between the two parts.

An apex may be formed at the choke point, adjacent to the rotor (the axis of rotation of the rotor in the feed direction).

Preferably, an opposed pair of choking deflectors are provided, one on either lateral side of the rotor. As the rotor will preferably rotate in one direction at any time (although the rotations direction may be reversible to change the direction of the throw), the choke point may be defined between one of the opposed pair of choking deflectors and the rotor.

The dimensions of the choking deflector(s) can be adjusted to adjust the angle of the angled wall which will in turn adjust the degree of choking around the rotor.

In one form, including an opposed pair of choking deflectors, the exit cowling/deflector is preferably rotatable to move the forward straight portion to align with the angle of the opposite choking deflector to change the direction of the throw (together with a reversal of the rotation direction of the rotor). This may act to fix the dimension of the exit on either side of the apparatus.

One or more guides may be provided to guide movement of the exit cowling/deflector. For example, the exit deflector may be provided with one or more guide rods which can seat in an arcuate slot to guide movement.

In a preferred embodiment, the movement of the exit deflector can cause corresponding reversal of the rotor direction or vice versa.

A conveying device such as a fan for example, may be provided adjacent to the exit from the apparatus to assist with conveying material away from the apparatus. In practice, the material will be accelerated by the rotor and this will propel the material aways from the apparatus. However, some material may not be propelled sufficiently far away from the apparatus and the provision of a conveying device such as a fan may assist.

The conveying device is preferably a pneumatic conveying device.

The conveying device may be located beneath the floor level of the apparatus, beneath the exit. The conveying device is preferably oriented laterally to direct airflow laterally.

The conveying device may be powered in any manner for example using the same drive as the rotor drive. A chain drive, geared drive or even a hydraulic drive could be used.

There may be a conveying device on both lateral sides to be actuated independently according to the throw direction. This actuation may be dependent on the movement of the exit deflector or the rotor direction.

### DETAILED DESCRIPTION OF THE INVENTION

In order that the invention may be more clearly understood one or more embodiments thereof will now be described, by way of example only, with reference to the accompanying drawings, of which:

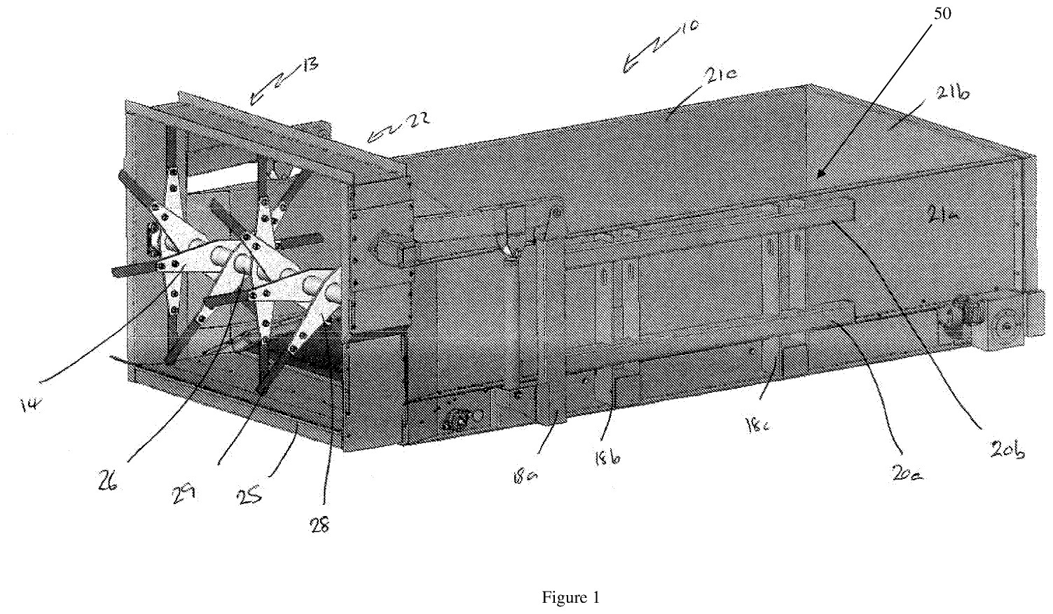

FIG. 1 is a perspective view of a bale handling apparatus of an embodiment.

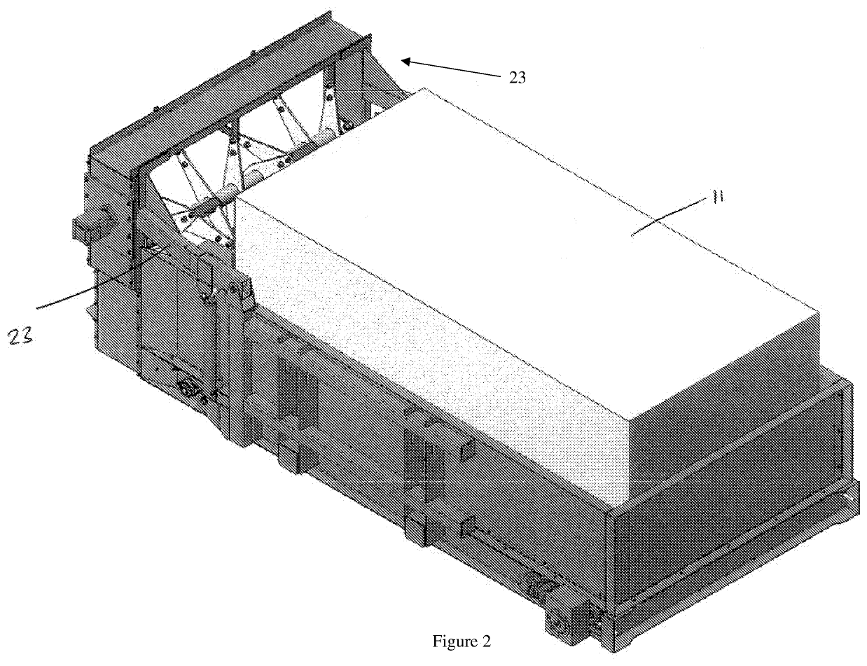

FIG. 2 is a further perspective view of the bale handling apparatus of FIG. 1 containing a straw bale.

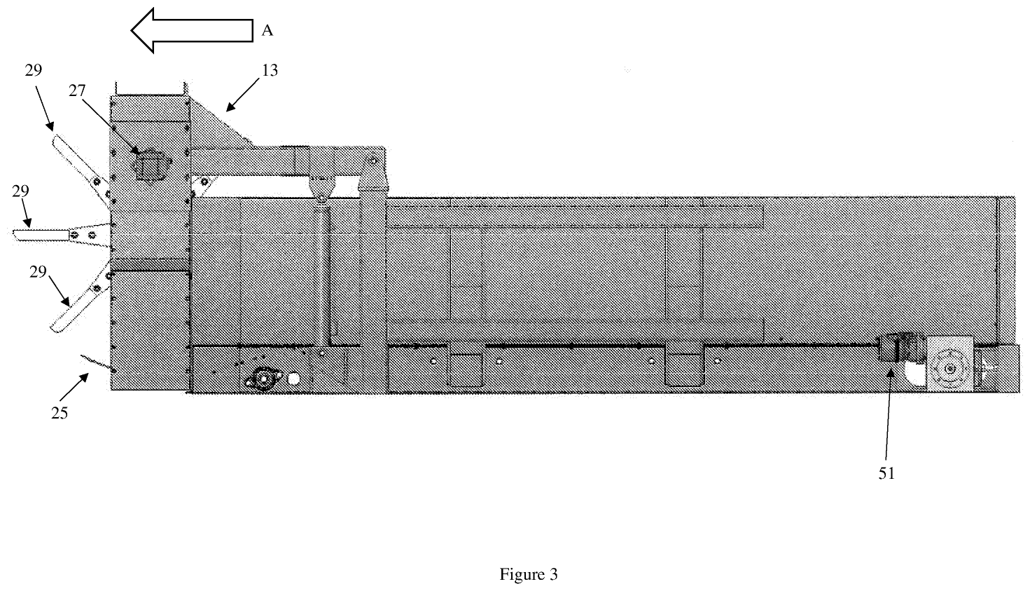

FIG. 3 is a side elevation of the bale handling apparatus of FIG. 1.

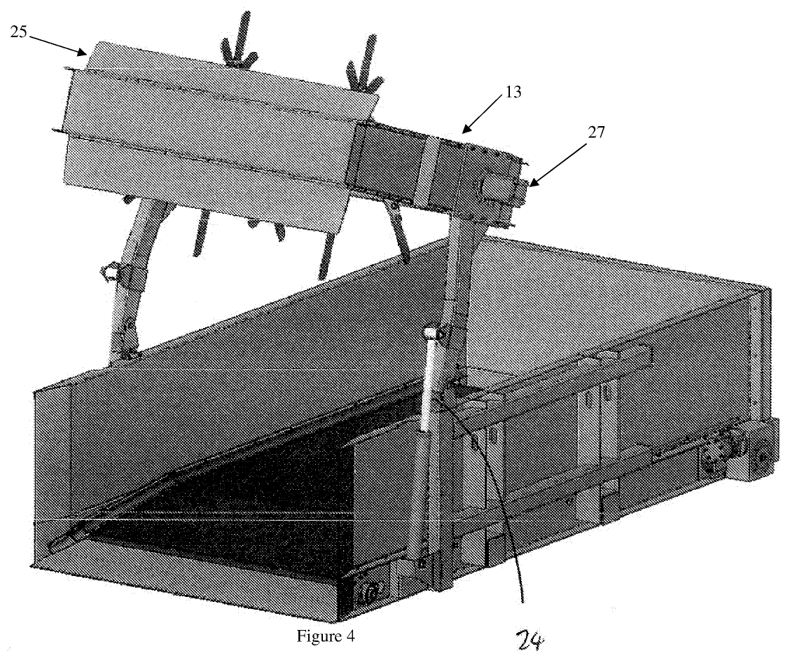

FIG. 4 is a perspective view of the bale handling apparatus of FIG. 1 in which the spreader head is in a raised position.

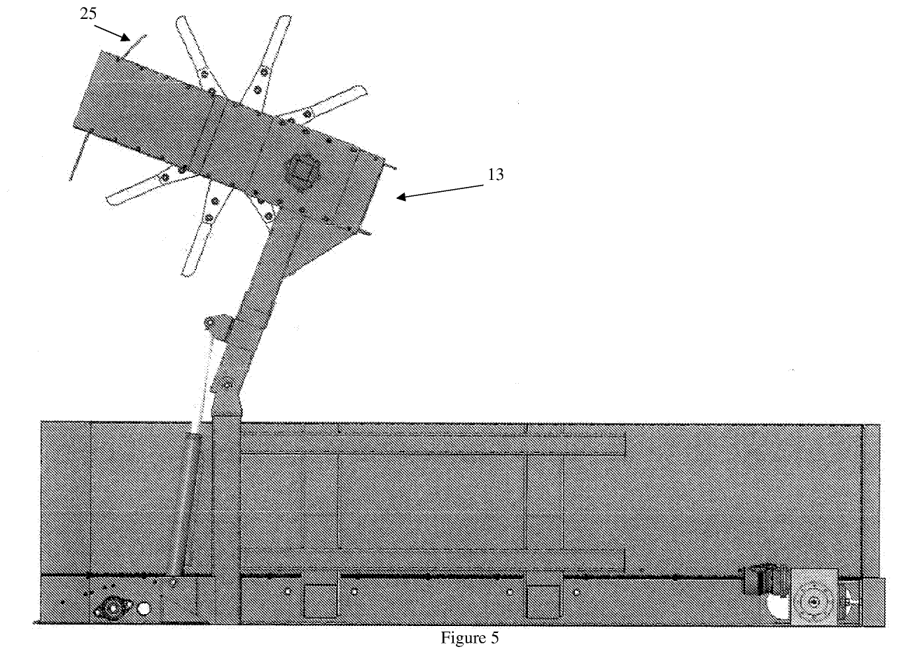

FIG. 5 is a side elevation of the bale handling apparatus of FIG. 1 arranged in the configuration of FIG. 4.

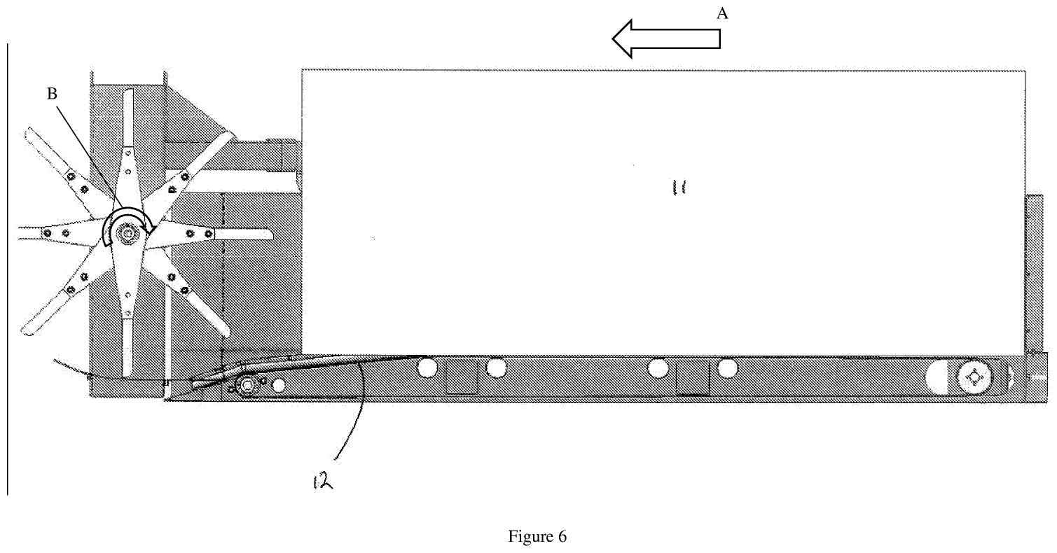

FIG. 6 is a part cut-away side view of the bale handling apparatus of FIG. 1.

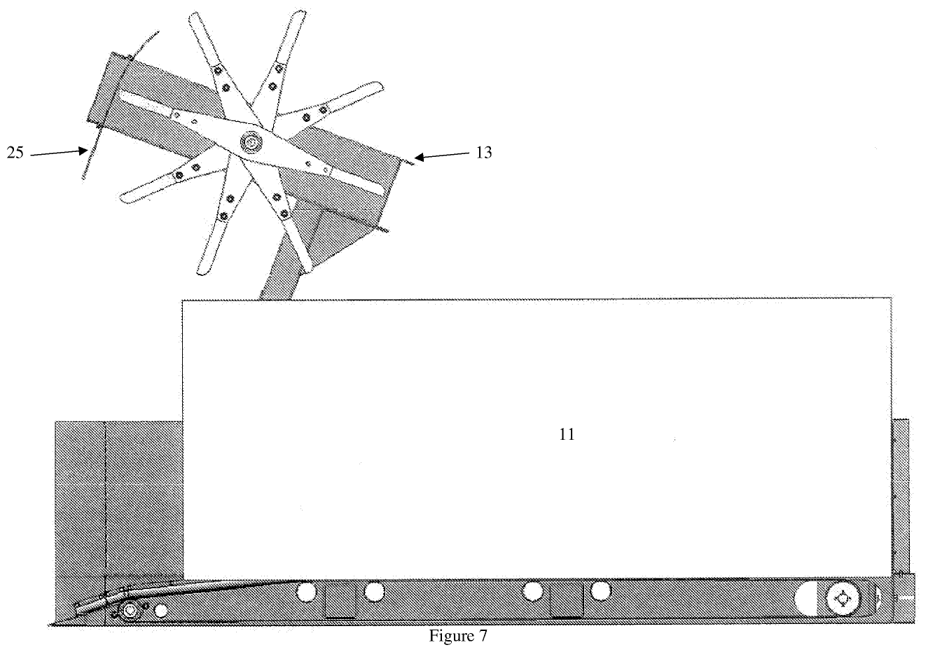

FIG. 7 is a part cut-away side view of the bale handling apparatus of FIG. 1 with the spreader head in a raised position.

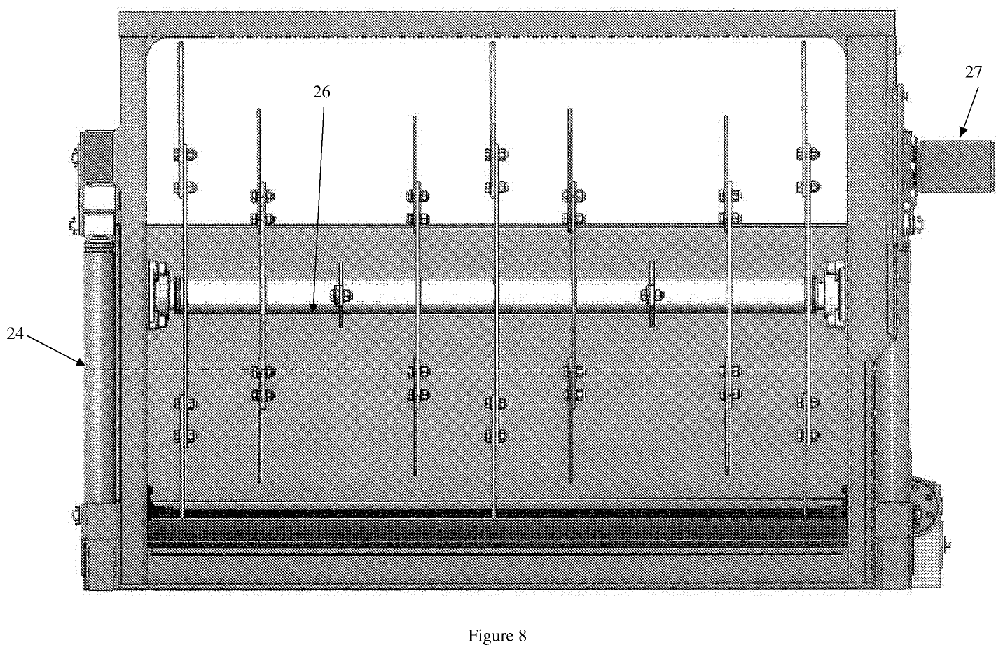

FIG. 8 is an end elevation view of the bale handling apparatus of FIG. 1.

FIG. 9 is an end elevation view of a spreader head of the bale apparatus of FIG. 1.

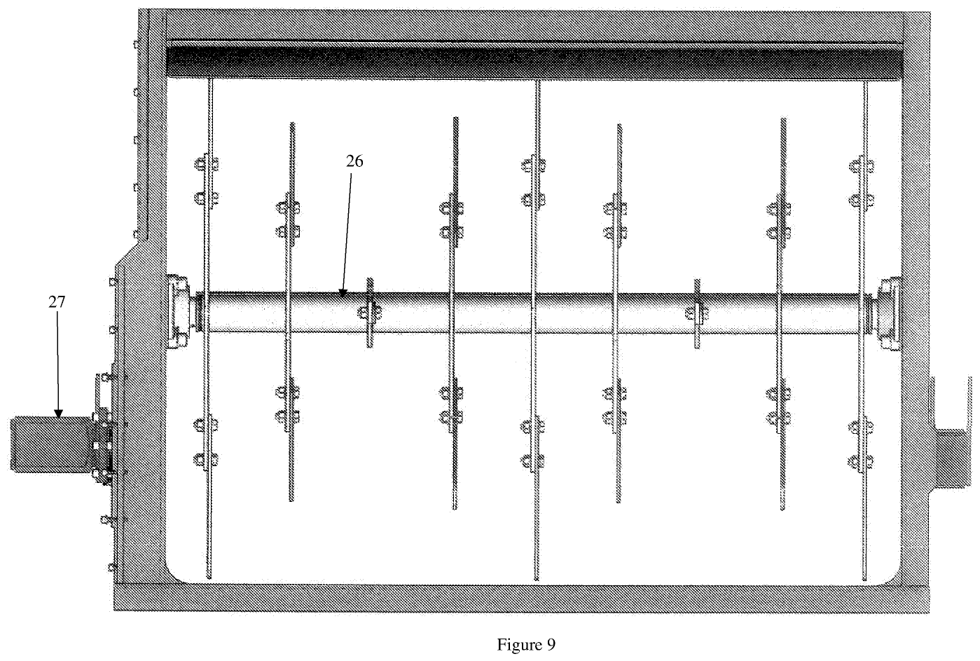

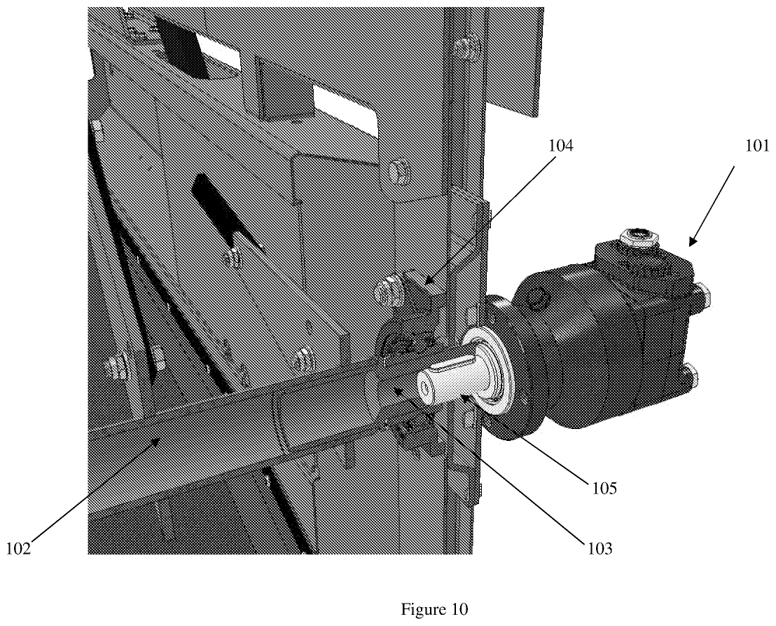

FIG. 10 is a detailed view of a rotor shaft and drive motor according to an embodiment.

FIG. 11 is a side elevation view of a forward end of a spreader apparatus of an embodiment with the near side walls removed for clarity.

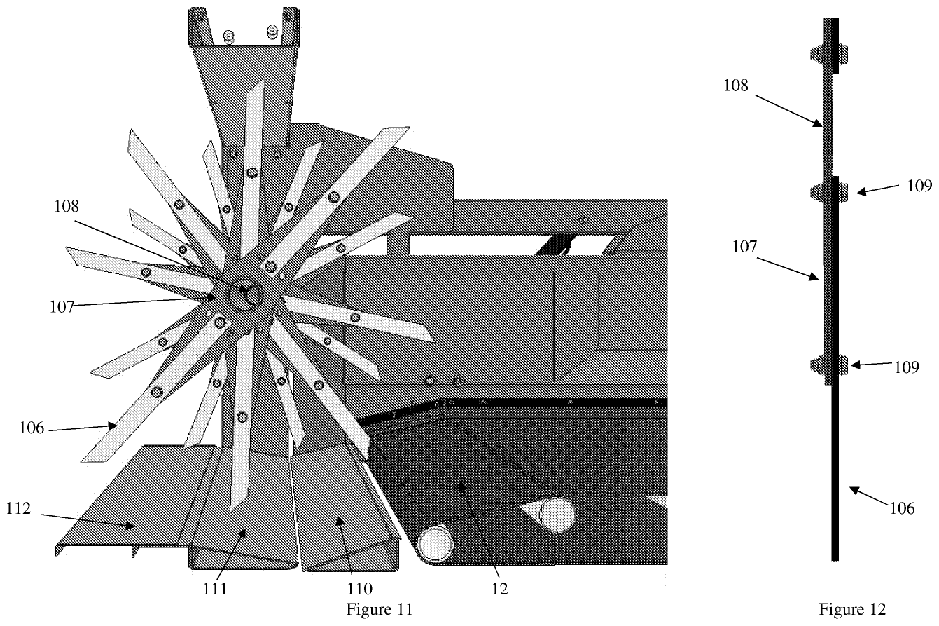

FIG. 12 is a front elevation view of part of a rotor arm showing blade attachment in an embodiment.

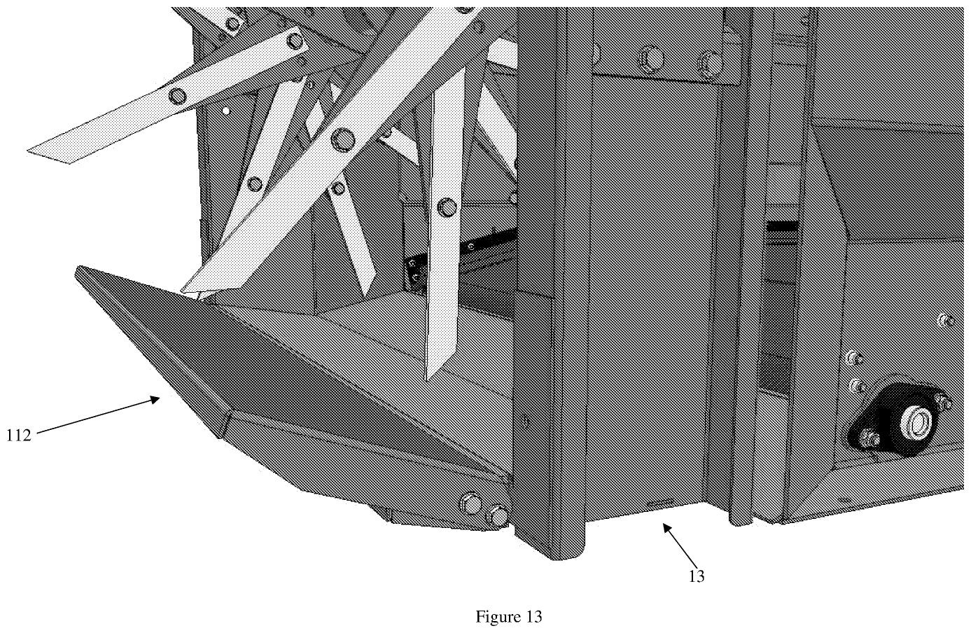

FIG. 13 is an axonometric view of a lower, forward part of a spreader apparatus showing a cowl in an upwardly angled orientation.

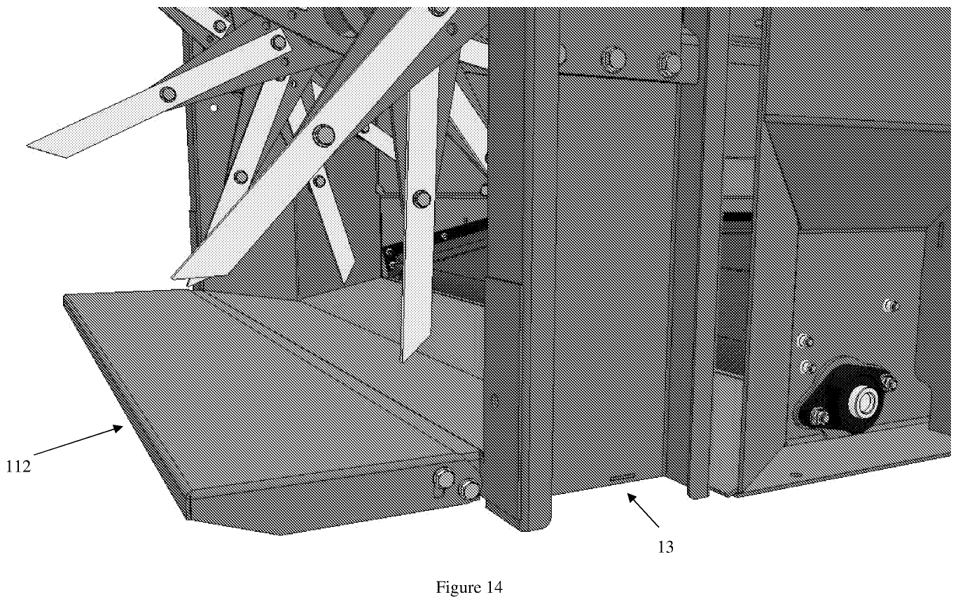

FIG. 14 is an axonometric view of a lower, forward part of a spreader apparatus as seen in FIG. 13 showing the cowl in a neutral orientation.

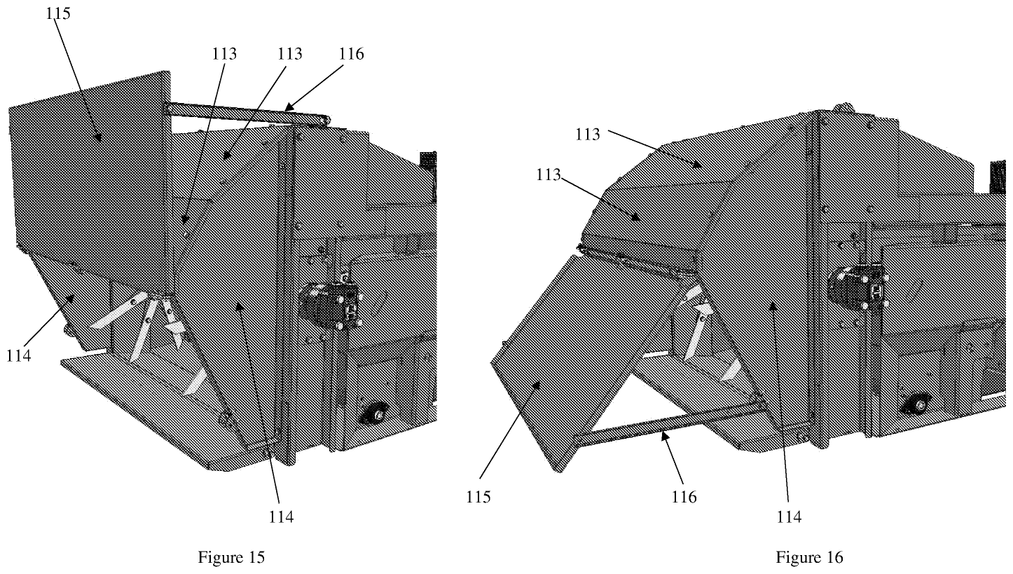

FIG. 15 is an axonometric view of a forward part of a spreader apparatus with a rotor cover and deflector in a raised position.

FIG. 16 shows the configuration in FIG. 15 but with the deflector in a lowered position.

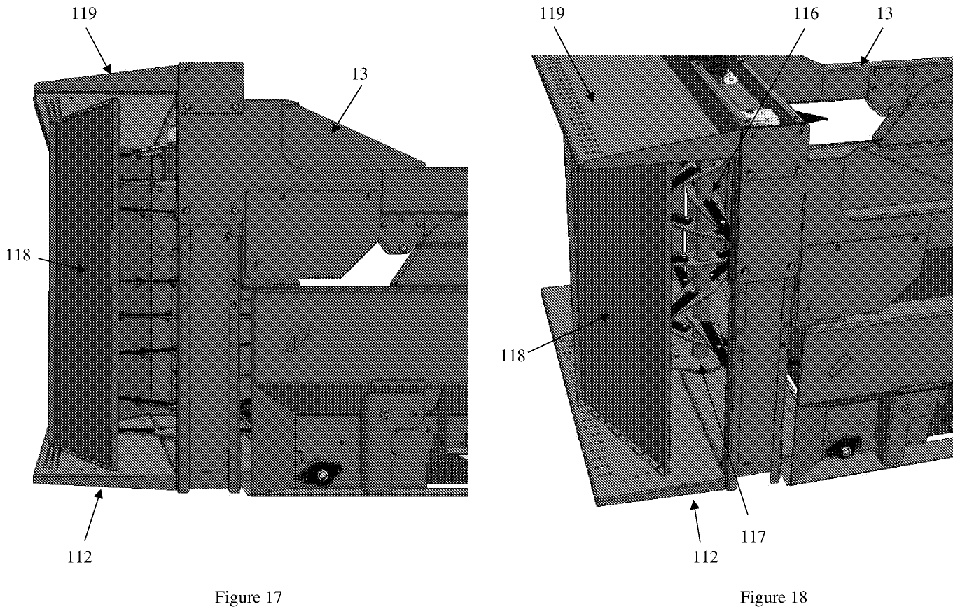

FIG. 17 is a side view of a forward part of a spreader apparatus in a side-throw configuration with a vertical rotor cowling in a narrow opening position.

FIG. 18 is an axonometric view of the configuration of FIG. 17.

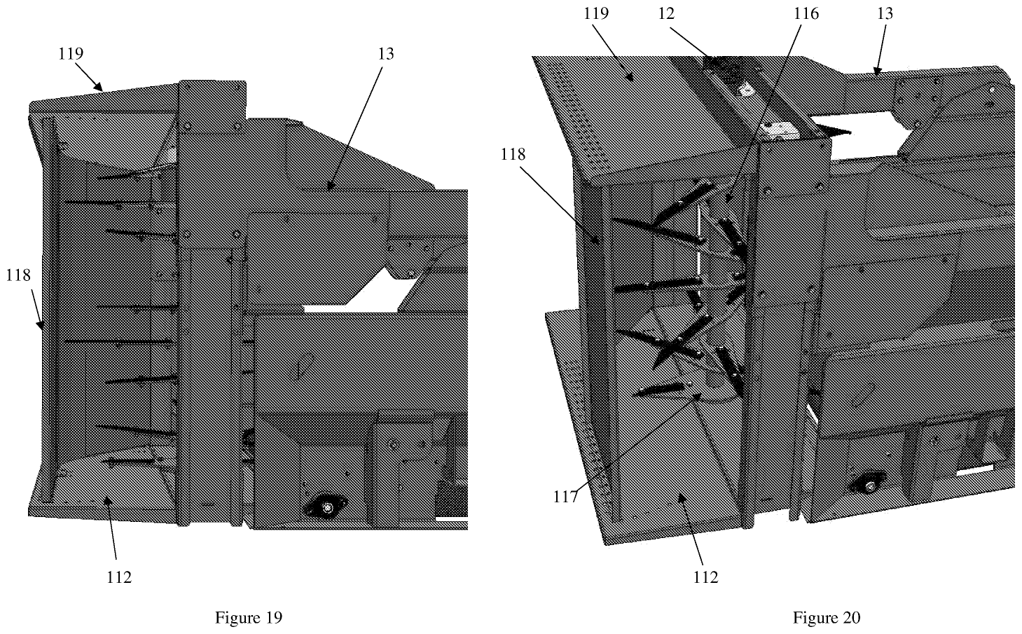

FIG. 19 is a side view of a forward part of a spreader apparatus in a side-throw configuration with a vertical rotor cowling in a wider opening position.

FIG. 20 is an axonometric view of the configuration of FIG. 19.

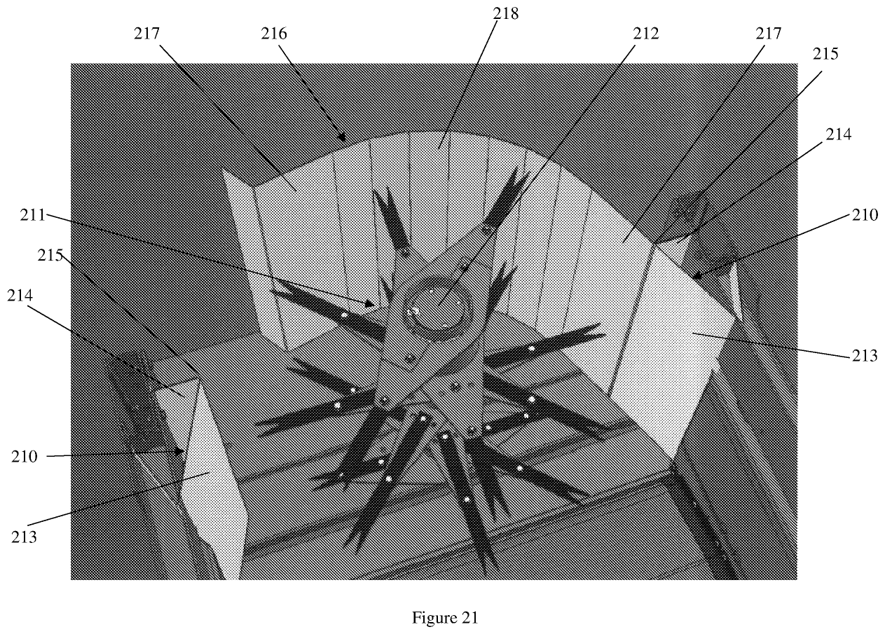

FIG. 21 is an axonometric top view of a spreader apparatus of an embodiment in a side-throw configuration and the top wall removed.

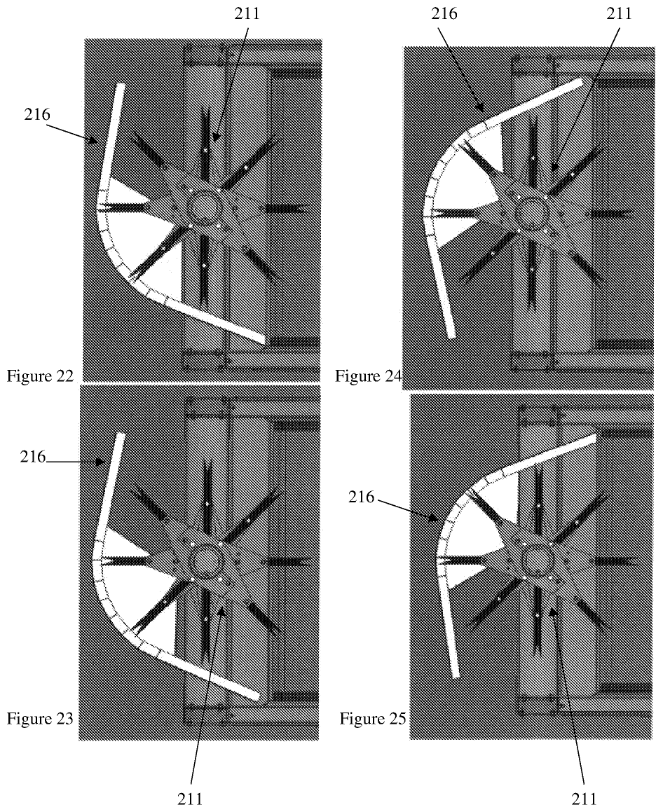

FIG. 22 is a top view of a spreader apparatus of an embodiment in a side-throw configuration with the exit deflector in a first position for right hand throw.

FIG. 23 is a top view of a spreader apparatus of another embodiment in a side-throw configuration with the exit deflector in a first position for right hand throw.

FIG. 24 is a top view of a spreader apparatus of an embodiment in a side-throw configuration with the exit deflector in a second position for left hand throw.

FIG. 25 is a top view of a spreader apparatus of another embodiment in a side-throw configuration with the exit deflector in a second position for left hand throw.

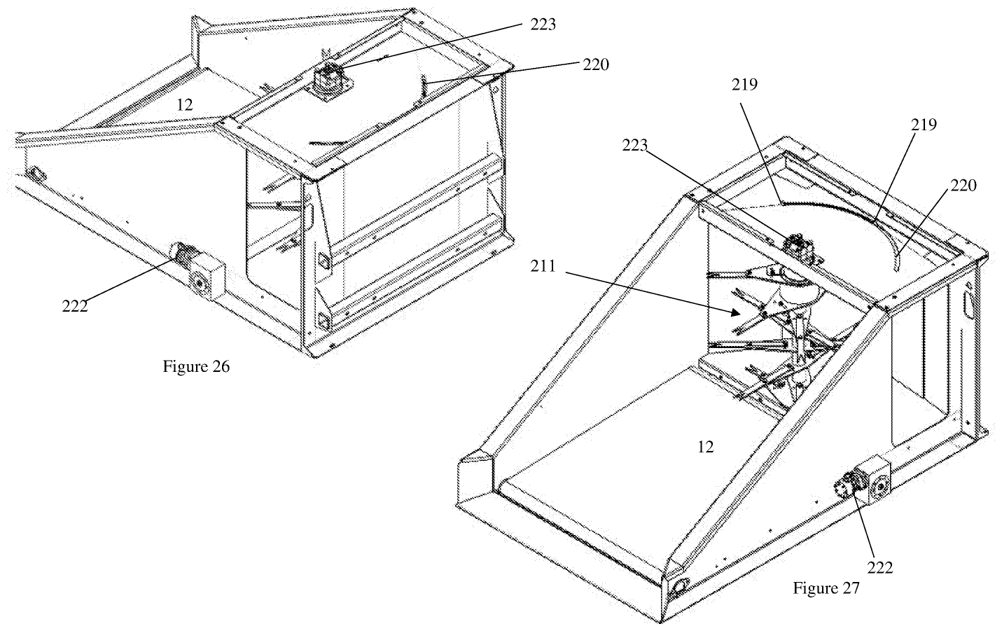

FIG. 26 is an axonometric view from the front of a rear loading, side throw spreader apparatus of an embodiment.

FIG. 27 is an axonometric view from the front of the rear loading, side throw spreader apparatus illustrated in FIG. 26.

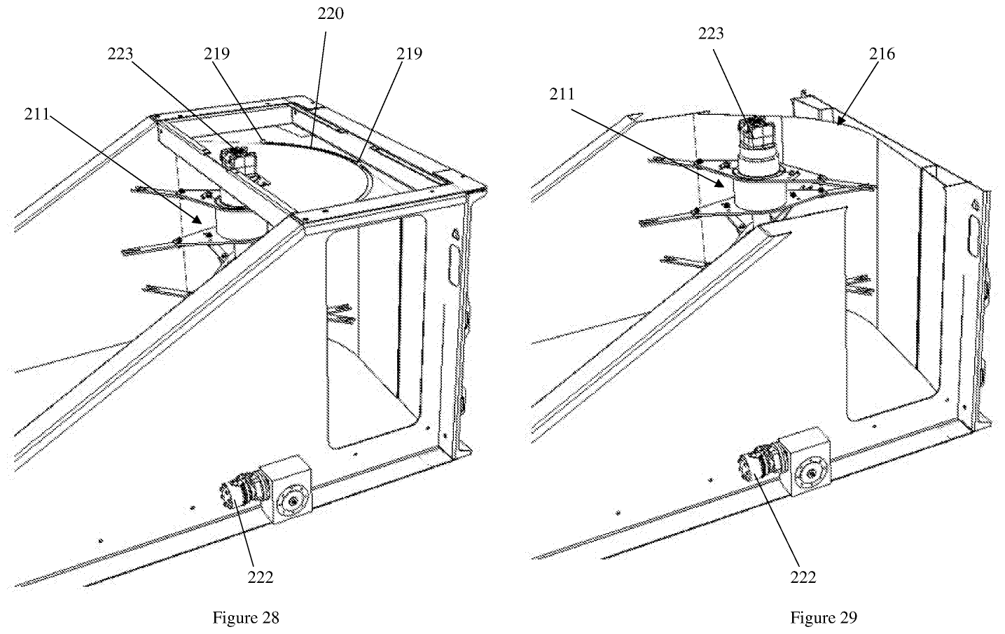

FIG. 28 is an axonometric view of the forward portion of the spreader apparatus illustrated in FIG. 26 with the top wall in place.

FIG. 29 is an axonometric view of the forward portion of the spreader apparatus illustrated in FIG. 26 with the top structure removed.

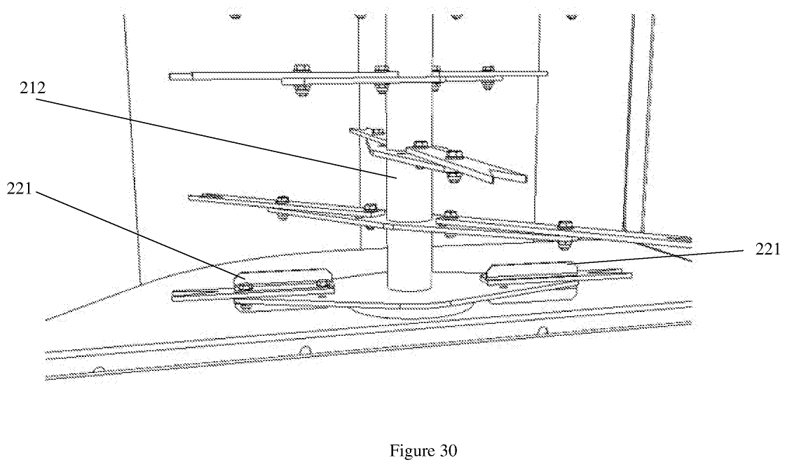

FIG. 30 is a side view of a rotor configuration for a side throw spreader apparatus with sweeper fins on the lowest rotor arm.

Referring to FIGS. 1 to 12, there is shown a bale handling apparatus 10 for spreading bale material, such as straw.

The bale handling apparatus 10 has a generally rectangular, box-like shape. In use, a bale 11 of material such as straw is inserted into the volume 50 of the box area, whereupon a conveyor belt 12 upon which the bale 11 sits, urges the bale 11 against a bale spreader head 13.

Rotors 14 of the spreader head transform the bale 11 into pieces at the same time as throwing these pieces out of the apparatus 10 in the direction of arrow A in FIGS. 3 and 6, thereby to provide a straw carpet which can be useful for animal bedding, or absorbing moisture on muddy ground, for example.

The rotors 14 illustrated comprise a pair of blades 29 provided as the tips of an elongate member extending around and from opposite sides of a rotating shaft. The rotors preferably rotate in the direction shown by Arrow B illustrated in FIG. 6.

The apparatus is carried upon the extended loading arm of a tractor, for example, known as a loader, ejecting straw to the side of the tractor. Connection of the apparatus to the loader is by means of a rectangular frame located on the side of the apparatus, while the power for the motors operating the conveyor belt and rotors is provided hydraulically, via the loader arm, from the tractor, normally by connection of a hydraulic circuit on the loader to one or more hydraulic motors provided on the apparatus.

The apparatus is given structural integrity by a combination of formed sheet metal webs and steel struts.

In use, the bale handling apparatus is supported by the loading arm of the tractor such that straw is ejected to the side of the tractor, i.e. the longitudinal struts run transverse to the front of the tractor.

Vertical walls 21a, 21b, 21c extend upwardly from the longitudinal struts 15, 16 and one lateral end strut 17d so as to form an open box for receiving a bale, the box having two closed sides and a closed end formed by the vertical walls 21a, 21b, 21c. The spreader head 13 is located at the end of the apparatus remote from the closed end.

The spreader head 13 comprises a rectangular frame 22, pivotally connected via spreader head bars 23 to the first vertical arms 18a, 19c located on the longitudinal bars 15, 16 of the chassis. The spreader head bars 23 may be raised and lowered under the action of a pair of hydraulic rams 24 on opposite sides of the chassis. Thus, the spreader head 13 may be moved from a first lower position as shown in FIG. 1 to a second raised position as shown in FIGS. 4 and 5.

In the lower position shown in FIG. 1, a cowl 25 is provided at the base of the spreader head 13.

A rotating shaft 26 extends between the sides of the spreader head 13. This is driven by a single motor 27. A plurality of rotor arms 28 are located on the rotatable shaft. These arms are in the form of plates into a central aperture through which the axle 26 extends. The two free ends of these rotor arms 28 form blades 29 for shredding the bales. The rotor arms 28 are fixed on the rotating shaft such that when viewed from the side adjacent blades 29 are located at 45° from each other such that four adjacent arms spaced blades at 45° to each other through 360°, as shown for example in FIG. 7. All of the blades 29 are driven for rotation along with the shaft by the single motor.

In the embodiments of FIGS. 1 to 9, a bale is loaded in the apparatus as shown in FIG. 2 by raising the spreader head into the position shown in FIG. 4, and then forcing a forward end of the spreader under the rear end of a bale. Rotation of the conveyer in a reverse direction can assist with drawing the bale into the spreader, perhaps while the spreader is forced forward by the loader.

Alternatively, one or more cylindrical bales could be rolled into the spreader by an operator.

Once loaded, the spreader head is then lowered.

The bale is then urged towards the spreader head whilst the spreader head is in the lowered position of FIG. 1 by the moving conveyor belt 12. As the bale is force through the spreader head, the rotating blades chop up the bale and project the shredded straw onto the ground.

The bale chains 31 are driven by a hydraulic motor 51 and reduction gearbox onto a chain drive onto a drive sprocket. The drive sprocket will have a friction clutch to protect the chain and machine when the bale is fully loaded and abuts the bale chamber back wall panel.

The bales can be loaded form the front of the apparatus, travelling up a bale slope, by driving the machine forward under the bale, then the bale chain teeth hook into the bale and drag the bale forward into the bale volume 50. The two bale chains 31 are located between the spreading blades 29 and dip below the bale surface of the spreading rotor to minimise any resistance from the chain 31, when the spreading rotor is accelerating the bale sections forward.

Alternatively, the bales can be loaded into the volume from the rear end of the apparatus through pivoting rear wall 56 which can form a ramp.

As shown in FIG. 10, in an embodiment, one motor 101 drives rotation of a single shaft 102 and all of the blades are mounted relative to the single shaft 102. In the embodiment illustrated in FIG. 10, the motor 101 is mounted in line with the shaft 102. A direct coupling 103 is provide between the motor into the rotor shaft. This removes the need for a chain and sprocket drive system, and rotor drive couplings which connect the motor to the rotor. An additional rotor bearing 104 may be provided to support the motor, with direct drive from the motor output shaft 105 into the rotor shaft 102.

The rotor motor 101 may be driven in both directions. Where the motor 101 is a hydraulic motor, a bidirectional valve or similar may be provided to change the rotation direction of the rotor from clockwise to anti clockwise for feeding and bedding for example.

As shown in FIGS. 11 and 12, each of the blades 106 may be mounted relative to the shaft through provision of a rotor arm 107. Each rotor arm 107 is shown located on the rotatable shaft. The rotor arms 107 are substantially planar. Each illustrated rotor arm 107 extends on each side of the rotatable shaft 102 approximately equally. A pair of rotor arms may be formed as a single unit. A substantially central aperture 108 through which the rotatable shaft 102 extends is provided through each rotor arm 107. Each rotor arm 107 illustrated in in FIGS. 11 and 12 is broader at the root and narrower at the tip.

As shown, each blade 106 extends from adjacent to the root of the rotor arm 107 and extends past the tip of the rotor arm 107. The blade 106 is attached to the rotor arm 107 at at least two positions 109, a first position at an inner end of the blade 106 which is located adjacent to the root of the rotor arm 107 and a second position adjacent to the tip of the rotor arm 107 (which is partway along the length of the blade 106). This configuration allows the blade 106 to reinforce or further strengthen the rotor arm 107.

Also shown in FIG. 11, where the spreader head 13 is movable, a forward end of the spreader chamber is provided with an angled portion 110 in front of the forward end of the conveyor 12. The angled portion 110 shown is substantially triangular. The angled portion 110 is angled to correspond with an angled forward end of the conveyor 12.

In use, the forward end of the spreader (with the spreader head 13 raised) can be moved to a position adjacent to a bale of material and the angled portion 110 then wedged beneath a part of the bale and moved until the conveyor 12 (operating in a reverse direction during loading) engages with the bale to draw the bale into the spreader chamber. The spreader head 13 can then be lowered.

The spreader head 13 may be provided with an angled portion 111. As shown, the angled portion 111 on the spreader head 13 is oriented in reverse to the angled portion 110 on the spreader chamber. This creates an angled depression when the spreader head 13 is closed (as shown in FIG. 11), which in turn may provide more clearance for the blades 106. It may also form a choke point to increase the velocity of the material ejected.

In the embodiment illustrated in FIG. 11, a cowl 112 is provided on the spreader head 13. The cowl 112 extends forwardly from adjacent to a forward end of the angled portion 111. The angled portion 111 on the spreader head 13 is mounted between the cowl 112 and the angled portion 110 in front of the forward end of the conveyor 12. A rear end edge of the cowl 112 aligns with a forward end of the angled portion 111 on the spreader head 13 to minimise any catching or obstruction of material as it exits the spreader head 13.

The illustrated cowl 112 is planar.

The cowl 112 may be fixed, as shown in FIG. 11 or movable as shown in FIGS. 13 and 14. The movable cowl allows the cowl 112 to be angled above a substantially horizontal position. The substantially horizontal position is shown in FIG. 14 and the angled position is shown in FIG. 13. Angling the cowl 13 may allow adjustable choking of the material in the rotor 102. Choking the material in the rotor may act to enhance material throw trajectory and consequently spread distance. As the choking effect is increased by elevating the cowl angle, the distance of throw of the material ejected may increase.

As shown in FIGS. 15 and 16, an upper part of the spreader head 13 may be provided with a rotor safety guard structure. Preferably, one or more cover members 113 are provided to enclose an upper, forward side of the rotor. As illustrated, the cover members 113 are mounted to the sidewalls 114 of the spreader head.

The apparatus may be provided with a deflector 115 to deflect material as it leaves the apparatus. The deflector 115 can be used to deflect material downwards into a feed trough, or feeder. A mounting arm 116 (one on each side of the spreader head) may be provided to hold the deflector in a desired position.

The embodiment of the apparatus illustrated in FIGS. 17 to 20, is configured for ‘side throw’ in which the material is ejected substantially sideways from a longitudinally mounted apparatus.

In this configuration, the spreader head 13 is movable but is provided with a single, centrally mounted rotor 116 which is oriented vertically, rather than the horizontally oriented rotor shown in FIGS. 1 to 16.

As shown, the vertical rotor 116 is modified at a lower end thereof. The lowermost rotor arm 117 is enlarged or oversized in comparison to the other rotor arms 107. The lowermost rotor arm 117 is also provided with shorter blades. The lowermost rotor arm 117 and/or blades may be provided to ‘sweep’ a central area about the lower end of the rotor 116 to prevent material wrapping about the rotor 116 at the lower end.

Adopting a vertical rotor cowling 118 as shown in FIGS. 17 to 20 to choke the rotor 116, facilitates side discharge/throw/spreading along narrow passageways, which are frequently found in farming.

The side throw apparatus illustrated in FIGS. 17 to 20 is provided with a pair of opposed vertical rotor cowlings 117, one on either lateral side of the spreader head. When used with a rotor which is drivable in either direction, this can facilitate left-hand side and right-hand side discharge/throwing/spreading of material.

The vertical rotor cowlings may be moveable or have an adjustable position. The position of a vertical rotor cowling 118 may be adjustable between a fully closed position in which material is prevented from leaving the spreader head to any of one or more open positions. A fully open position may be one in which the vertical rotor cowling is substantially aligned with the direction of the conveyor. Where the discharge aperture defined by the cowling is small between 300 mm-500 mm wide, this is ideal for narrow doorways as found in horse stables and pig hutches.

In the illustrated embodiment, the vertical rotor cowling 118 on the near side is moveable to set the opening position, and the vertical rotor cowling on the far side (obscured in the Figures) is fixed in position to allow exit of material on only one side of the spreader apparatus.

The vertical rotor cowling 118 is mounted between an upper guide 119 and a fixed lower cowl 112.

The position of the vertical rotor cowling 118 may be adjustable to accommodate varying types of straw bales, wafer thickness and bale density. If the cowling 118 is too tight at the compression point, the rotor 116 will likely stall in the material.

After the compression point, the cowling 118 can be adjustable/variable. If the rotor 116 is choked too much, the material can return into the machine and not be ejected as intended. If not choked enough, throw distance is reduced and the rotor 116 can stall and block. A cowling 118 which is adjustable in position to optimise these factors is therefore preferred.

As shown in FIGS. 19 and 20, the exit opening defined by the cowling 118 is larger than the exit opening shown in FIGS. 17 and 18.

The side throw spreader apparatus illustrated in FIGS. 21 to 25 includes a pair of opposed choking deflectors 210, located adjacent to the rotor 211, and particularly to the axis of rotation of the rotor, the rotor shaft 212. Each choking deflector 210 has an angled wall 213 laterally inwardly toward the rotor 211. The angled wall 213 of the illustrated embodiment is planar and smooth. The angled wall 213 illustrated in FIG. 21 extends from a point behind the rotor shaft 212 to a point at least in line with the rotor shaft 212. The angled wall 213 extends inwardly towards the rotor 211 from the plane of the sidewall of the apparatus.

A second wall 214 extends away from the angled wall 213 at an angle to hold the angled wall 213 at the desired angle.

The angled wall 213 and second wall 214 of the illustrated embodiment are manufactured from a single piece of material bent or formed at an angle.

An apex 215 is formed at the choke point, adjacent to the rotor shaft 212.

As the rotor 211 rotates in one direction at any time (although the rotation direction may be reversible to change the direction of the throw of material), the choke point is defined between one of the opposed pair of choking deflectors 210 and the rotor 211.

The dimensions of the choking deflector(s) 211 can be adjusted to adjust the angle of the angled wall 213 which will in turn adjust the degree of choking around the rotor 211.

The side throw spreader apparatus illustrated in FIGS. 21 to 25 also includes an exit cowling/deflector 216. The exit cowling/deflector 216 illustrated extends from adjacent to one choking deflector 210, forwardly and laterally about a forward side of the rotor 211 to guide material to one side of the apparatus.

The clearance between the inner side of the exit cowling/deflector 216 and the tips of the blades may be between 30-60 mm, which acts to accelerate the material outwardly and maintain a sufficient amount of material about the rotor 211.

The degree of choking is important as there should be a sufficient amount of material around the rotor 211 so that the rotor 211 can partially separate the material but does not break the material up further.

In the illustrated form, a single exit cowling/deflector 216 is provided. This exit cowling/deflector 216 is moveable, allowing the direction of throw to be changed from right hand to left hand (with an appropriate rotation direction of the rotor 211) as shown in FIGS. 22 to 25. In this embodiment, the exit cowling/deflector 216 is rotatable, to change the direction of throw.

The exit cowling/deflector 216 may be moved by any mechanism (not shown) such as a chain drive or a hydraulic drive. The mechanism will preferably be bi-directional to move the exit cowling/deflector 216 in both directions, to assume the positions in FIGS. 22 to 25.

The exit cowling/deflector 216 illustrated in FIGS. 21 to 25 includes a straight portion 217 at both ends and an arcuate portion 218 to change direction, therebetween. The rearmost straight portion preferably acts to smooth the change of direction of the material from the choking deflector 211. The forward straight portion at the exit, directs the material sideways, but not rearwardly as it exits. The exit cowling/deflector 216 is positioned in use such that the forward straight portion is oriented laterally to ensure that material is not directed rearwardly.

The illustrated exit cowling/deflector 216 is rotatable to move the forward straight portion to align with the angle of the opposite choking deflector 210 to change the direction of the throw (together with a reversal of the rotation direction of the rotor) as shown in FIGS. 22 to 25. This movement can also act to fix the dimension of the exit on either side of the apparatus.

As shown in the rear loading side throw spreader apparatus illustrated in FIGS. 26 to 29, one or more guides may be provided to guide movement of the exit deflector 216. In this embodiment, as shown in FIGS. 26 to 28, the exit cowling/deflector 216 is provided with a pair of guide rods 219 which seat in an arcuate slot 220 to guide movement.

The rear loading side throw spreader apparatus illustrated in FIGS. 26 to 29 differs from the front-loading, side throw spreader apparatus illustrated in FIGS. 17 to 25 in that the operator has a significantly better view due to the orientation of the spreader. This embodiment also shows the drive 222 for the bale feed belt and the rotor drive 223.

The rear-loading side throw spreader apparatus is also smaller and lighter option, than the front-loading spreader apparatus as it removes the need for hydraulic cylinders to lift head for bale loading for example. It also reduces weight significantly on the front of the machine and fulcrum effect.

The rear loading side throw spreader apparatus may position the exit cowling/deflector 216 based on the rotor direction. The floor of the rotor spreading section of the spreader is at the same level as the top of the bale feed belt.

As shown in FIG. 30, the lowest rotor arm may be provided with vertical paddles or fins 221 to generate sweep the rotor floor and/or create a pneumatic force to blow small pieces of straw away from the spreader. As mentioned above, this can be coupled with a laterally directed fan to provide increased pneumatic force.

The one or more embodiments are described above by way of example only. Many variations are possible without departing from the scope of protection afforded by the appended claims.

1. A bale spreading apparatus comprising:
a box frame which retains a bale of material,
a conveyor on which a bale rests, the conveyor being operative to urge the bale in a longitudinal direction towards a spreader head which ejects bale material from the apparatus,
wherein the spreader head comprises one or more rotors, each of the one or more rotors comprising a vertically mounted rotatable shaft and a series of blades being mounted on at least one of said shafts.

2. The bale spreading apparatus as claimed in claim 1 wherein a single shaft is provided with all of the blades mounted relative to a single shaft.

3. The bale spreading apparatus as claimed in claim 1 wherein no more than two blades are radially aligned about the shaft.

4. The bale spreading apparatus as claimed in claim 1 wherein a pair of blades are provided as respective opposite tips of an elongate member extending around and from opposite sides of the shaft.

5. The bale spreading apparatus as claimed in claim 2 wherein the single shaft is mounted substantially centrally of the apparatus relative of the bale.

6. The bale spreading apparatus as claimed in claim 2 comprising a rotor motor coupled to drive the single shaft in both directions.

7. The bale spreading apparatus as claimed in claim 1 wherein each blade is rectangular with a V-shaped notch in a free end thereof.

8. The bale spreading apparatus as claimed in claim 1 wherein the spreader head is moveable to load one or more bales of material by raising the spreader head and then loading the one or more bales through a forward end of the spreader.

9. The bale spreading apparatus as claimed in claim 1 wherein the spreader head is fixed, and one or more bales are loaded from an end opposite to the spreader head.

10. The bale spreading apparatus as claimed in claim 1 wherein the series of blades are mounted on each shaft in opposed pairs via a rotor arm mounted to the shaft and the blades mounted on opposed ends of the rotor arm.

11. (canceled).

12. The bale spreading apparatus as claimed in claim 1 wherein a floor around the shaft within a span of the blades is planar.

13. The bale spreading apparatus as claimed in claim 1 further comprising at least one choking deflector located adjacent to the rotor.

14-17. (canceled).

18. The bale spreading apparatus as claimed in claim 1 comprising an opposed pair of choking deflectors, one on either lateral side of the rotor.

19. The bale spreading apparatus as claimed in claim 1 further comprising a substantially vertically extending exit cowling located at least partially in front of the rotor relative to a feed direction of the bale.

20. The bale spreading apparatus as claimed in claim 19 wherein the exit cowling is moveable to facilitate left-hand side and right-hand side discharge of bale material from the spreader.

21. (canceled).

22. The bale spreading apparatus as claimed in 21 claim 19 wherein the exit cowling includes a straight portion at either end and an arcuate portion therebetween.

23. (canceled).

24. The bale spreading apparatus as claimed in claim 19 wherein movement of the exit cowling causes a corresponding reversal of the rotor direction or vice versa.

25. The bale spreading apparatus as claimed claim 1 further comprising a pneumatic conveying device provided adjacent to the exit from the spreader to assist with conveying material away from the spreader.

26. (canceled).

27. The bale spreading apparatus as claimed in claim 25 wherein the pneumatic conveying device is oriented laterally to direct airflow laterally.

28. (canceled).

29. A bale spreading apparatus comprising:
a box frame which retains a bale of material,
a spreader head, and
a conveyor on which a bale rests, the conveyor being operative to urge the bale in a longitudinal direction towards the spreader head which ejects bale material from the apparatus,
wherein the spreader head comprises one or more horizontally mounted rotatable shafts, and wherein a series of blades is mounted on at least one of said one or more horizontally mounted rotatable shafts.
